(19) United States
(12) Patent Application Publication
(10) Pub. No.: US 2011/0217995 A1
(43) Pub. Date: Sep. 8, 2011

(54) SECURITY MECHANISMS TO PROTECT SMS EXCHANGE IN TELECOMMUNICATION NETWORKS

(75) Inventors: BORJA JIMENEZ ALDAMA, PARIS (FR); BASTIEN PASCAL VALERY MURZEAU, SAINT MEDARD DE GUIZIERES (FR); DAVID SIMON DOMINIQUE STIENNE, PARIS (FR)

(73) Assignee: PALOMA NETWORKS SAS, Paris (FR)

(21) Appl. No.: 13/031,676

(22) Filed: Feb. 22, 2011

Related U.S. Application Data
(60) Provisional application No. 61/309,974, filed on Mar. 3, 2010.

(51) Int. Cl. H04W 4/12

(52) U.S. Cl. 455/466

(57) ABSTRACT

A mobile device (301) for use in a wireless communication network, said mobile device comprising a processor (335) arranged to send a short message delivery receipt to a communication party, after normal receipt by the communication device of a first short message sent by said communication party, said first short message delivery receipt being in a byte format different than the received first short message, send mobile originated (MO) short messages, of the same byte format as the received first short message, transfer the received first short message to an identification module (350) of the mobile device when said first short message is identified as a data update message comprising a data update for said identification module, either one of the processor and the authentication module being further arranged, upon determination by the authentication module that the communication party requested that proof of receipt (PoR) data for the data update be inserted in a new MO short message serving as a PoR message to said communication party, to discard said PoR data request when said communication party matches a predefined criterion.

### FIELD OF THE INVENTION

This invention relates generally to wireless communication and more specifically to the exchange of short messages exchanges in a wireless network.

### BACKGROUND OF THE INVENTION

ETSI (European Telecommunications Standards Institute) and 3GPP (Third Generation Partnership Project) standard organizations have defined a short text message (SMS) service that allows mobile equipments to send and received text messages using 2G (GSM) and 3G (UMTS) wireless communication (or mobile) networks. These text messages can either be transported by Circuit-Switched (CS) or Packet-Switched (PS) depending on the available bearers and also Mobile Equipment (ME), the Universal Subscriber Identity Module (SIM or (U)SIM) present in the ME, network operator strategies or user preferences for instance. The SIM is sometimes referred to an authentication module. The ME may be indifferently referred to here after as a wireless device or mobile device.

This service has encountered a huge success giving people a new way of communication using the capabilities provided by the mobile networks and more widely Signaling System 7 (SS7) networks. However this communication service is not just restricted to human communications. SMS can be also reused for machine-to-machine communications. For instance this is the case of the SIM card remote management service. Hence SMS can be of at least two types. A first example of a SMS type could be a display type, to display on a ME screen a short message sent from another ME. Another type could be the (U)SIM data download or (U)SIM data update (referred to as data download or data update in short) as described here after.

A SMS or short message, in short, generally comprises two parts. A first part is the transport protocol (TP) header comprising a number of parameters linked to the sender, the recipient, the type of SMS . . . A second part is the payload which corresponds to the short message content itself, like a message to be displayed or the data to update a SIM. One may note that the data update may also be intended for another entity than the SIM.

The sender or sending entity of the short message can be identified in the SMS header through an identifier. This identifier may be for instance the network identifier of the sending entity or a phone number. Such an identifier can be used to know the sender's identity, for example when the mobile device is to reply to the received short message. The identifier can also be used to run a number of verifications on the sending entity.

One way for mobile operators or third parties to remotely manage parameters, services and applications installed in the (U)SIM card is through the standardized SMS transport protocol described in the 3GPP document “Digital cellular telecommunications system (Phase 2+); Specification of the SIM Application Toolkit (SAT) for the Subscriber Identity Module—Mobile Equipment (SIM-ME) interface (3GPP TS 11.14 version 8.17.0 Release 1999)”. This document describes the data update type of SMS through the so called data download procedure to the (U)SIM using short text message. When identified as a data update type of short message, the short message is passed on by the ME to the SIM card for a subsequent update of the USIM. The updates for instance can be a new SIM application and/or commands to existing SIM based applications. Such a message is not displayed by the ME.

Using this short message channel a remote management platform, i.e. a communication party of the mobile network, can send management commands to the (U)SIM applications. These messages are thus sent by the management platform using the standardized SMS procedures to the ME.

Generally, upon each SMS reception, the ME will check specific SMS header parameter values and find out the destination entity able to read (i.e. interpret) the SMS payload. There are several possible destination entities at reception:
the (U)SIM card, for a data update type of SMS,
a terminal equipment that may be connected to the ME,
the ME itself, for a display type of SMS, for instance if the SMS sender wants to display the content of the text message on the ME screen instead of storing it in the SIM.

The final destination of the SMS is determined by two parameters, already mentioned in relation to FIG. 4 and included in the TP header of the SMS as defined in “3GPP TS 23.040 v9.1.0 3rd Generation Partnership Project; Technical Specification Group Core Network and Terminals; Technical realization of the Short Message Service (SMS)—Release 9”:
TP-Data Code Scheme (TP-DCS), which indicates the number of bits used for the alphabet coding,
TP-Protocol Identifier (TP-PID), which indicates the type of SMS (for example a (U)SIM data download).
In the 3GPP standard, a typical data download short message will corresponds for instance to TP-DCS=“Class 2” ((U)SIM specific message) and TP-PID=“(U)SIM data download”. It is defined in the 3GPP standards that remote (U)SIM card management procedures can include a feedback message sent by the (U)SIM card to allow the sending entity to be informed about the outcome of the sent management command. This message may be called a proof or receipt (PoR) message and corresponds to a feedback message confirming the use by the SIM of the original SMS data update. The PoR message may comprise some PoR data encapsulated therein and detailing the status of the data update usage or implementation by the SIM.

The sending entity, i.e. the remote management platform, can specify in its original short message whether a PoR message (PoR in short) is required or not. In addition to this, the sending entity can also specify how this PoR must be sent back to the sender. In other words, the sending entity may choose how the PoR data is encapsulated in a feedback message using one of the following feedback methods:
Inside an SMS delivery receipt. The standard describes an SMS (or short message) delivery receipt sent by the ME back to the sending entity after normal receipt by the ME of a short message. This delivery receipt is intended to confirm the good transmission of a short message to the ME. In the standard, this short message delivery receipt is sent only if the sending entity requested it. This SMS delivery receipt is in a byte format different than a SMS,
Inside a new mobile originated short message (MO-SMS). According to the standard, the ME can send mobile originated (MO) short messages, of the same byte format as a received short message. In a MO short message, the (U)SIM generally instructs the MO (i.e. its processor) to generate such a MO SMS.

In both instances, a PoR message (comprising the PoR data) is generated and sent back to the remote management platform. If the PoR is requested by the remote management platform, one of the two feedback methods or PoR messages may be used. PoR request and feedback method are coded within one parameter called the Security Parameter Indicator (SPI—see FIG. 4).

The SPI is included in the header (called command header) defined in 3GPP TS 23.048 v5.9.0 Generation Partnership Project; Technical Specification Group Core Network and Terminals; Security mechanism for the (U)SIM application toolkit; Stage 2 (Release 5). By definition, this parameter is coded on two-bytes. If a sending entity requests a proof of receipt, it must set the first two bits (b2 b1 ) of the second byte to 0 1 or 1 0. Such proof of receipt must be sent back, either using the SMS delivery receipt message (by setting the sixth bit (b6) of the second byte to 0) or in a new MO SMS initiated by the (U)SIM card (by setting the sixth bit (b6) of the second byte to 1).

One may note, as seen in FIG. 4, that the TP-PID, TP-DCS and TP-OA parameters are not in the same message layer as the SPI parameter. The first are in the TP header of the SMS while the latter is in the command header of the TP payload.

For security reasons it is highly important that any request targeting the (U)SIM card, such as a PoR request, comes from a trusted source. A “trusted” sending entity is a communication party which is authorized to communicate with the (U)SIM, authorization being granted to send and receive SMS with the (U)SIM. A typical trusted source would be a mobile operator's over-the-air platform.

The way the SMS response is handled has not been precisely described in the literature so far, leaving a large flexibility in the implementation for card manufacturer. This leads to security issues if an non trusted or unsafe communication party requires a PoR from the (U)SIM card using the existing feedback methods (answer included in the SMS delivery receipt or a new mobile originated SMS).

Confirming the receipt from an unsafe party can impact the (U)SIM card operations. Services and applications where the (U)SIM card is involved could be altered and unexpected results could be observed. For instance, usual mobile network services would be altered and lead to embarrassing situations for a mobile operator, if its network services are no longer operational with MEs.

Today there is still a need for a ME and/or a network element capable of controlling the data update SMS sent by a remote management platform. There is a further need for a ME and/or network element capable of rejecting a PoR when requested by an unsafe entity.

### SUMMARY OF THE PRESENT SYSTEM AND METHOD

It is an object of the present system, processor and method to overcome disadvantages and/or make improvements in the prior art.

To that extent, the present system proposes a communication device according to claim 1, a method for controlling the delivery receipt sent by a mobile device as in claim 9, a communication system as in claim 10 and a computer program as in claim 11.

Thanks to the present communication device, a solution is provided to avoid any unwanted PoR request from non trusted source. Once the SIM identifies that the communication party, i.e. the sending entity, has requested a PoR data, for instance when the sending entity matches a predefined criterion, the PoR request will be discarded, i.e. not processed.

### BRIEF DESCRIPTION OF THE DRAWINGS

The present telecommunication system, telecommunication device and method are explained in further detail, and by way of example, with reference to the accompanying drawings wherein:

FIG. 1 shows an exemplary diagram according to an embodiment of the present method,

FIG. 2 shows another exemplary diagram according to an embodiment of the present method,

FIG. 3 shows an exemplary embodiment of a mobile device according to the present system

FIG. 4 shows an exemplary illustration of known SMS,

FIG. 5 shows an exemplary embodiment of the present system; and,

FIG. 6 shows another exemplary diagram according to another embodiment of the present method

### DETAILED DESCRIPTION OF THE PRESENT SYSTEM AND METHOD

The following are descriptions of exemplary embodiments that when taken in conjunction with the drawings will demonstrate the above noted features and advantages, and introduce further ones.

In the following description, for purposes of explanation rather than limitation, specific details are set forth such as architecture, interfaces, techniques, etc., for illustration. However, it will be apparent to those of ordinary skill in the art that other embodiments that depart from these details would still be understood to be within the scope of the appended claims.

For purposes of simplifying a description of the present system, the terms “operatively coupled” or “coupled” will refer to a connection between devices and/or portions thereof that enables operation in accordance with the present invention. For example, an operative coupling may include one or more of a wired connection and/or a wireless connection between two or more devices that enables a one and/or two-way communication path between the devices and/or portions thereof. For example, an operative coupling may include a wired and/or wireless coupling to enable communication between a mobile device and a media gateway. An operative coupling may also relate to an interaction between a SIM card and the mobile device hosting it.

In the illustrations here after, unless mentioned otherwise, reference will be made to a cellular communication network, comprising one or more mobile or wireless communication devices hosting a SIM card. This is in no way a limitation of the present invention as the present teachings can be implemented in other wireless communication networks comprising mobile devices hosting an identification module, such as for instance CDMA (Code division multiple access) networks.

FIG. 5 is an exemplary illustration of the different entities in the present system. A sending entity or communication party 510 is operable to send data download SMS to a mobile equipment 530 of the present system. The SMS service is enabled by a SMS Service Center (SMS—SC or Short Message Service Center 520 and other nodes and platform of the wireless communication network (not illustrated in FIG. 5 for simplification purpose).

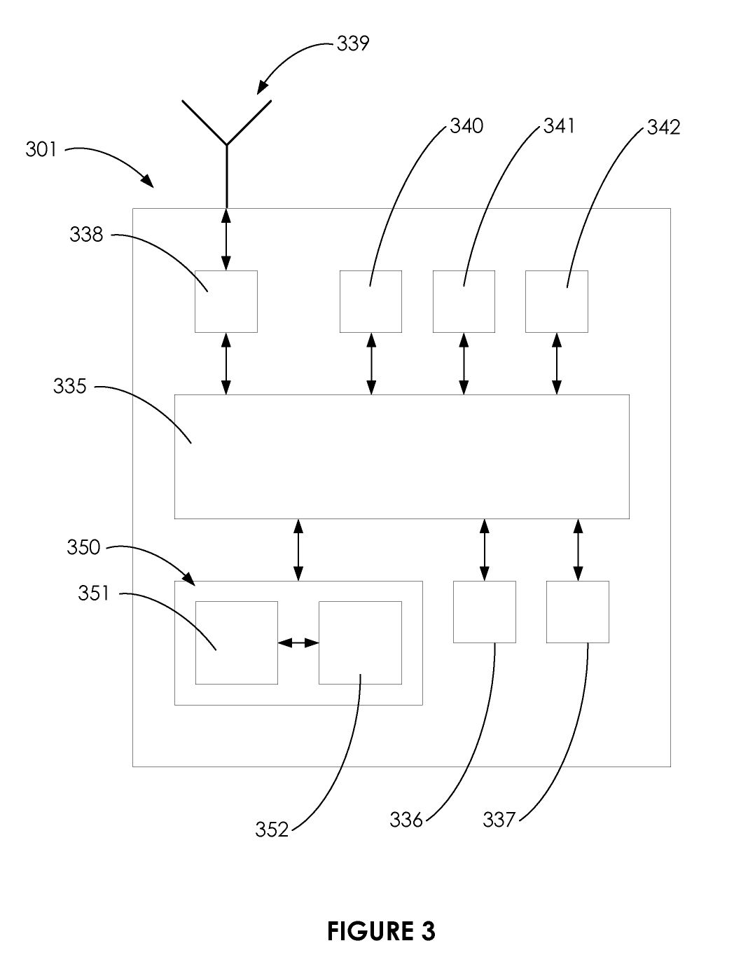

FIG. 3 illustrates an exemplary embodiment of a mobile device according to the present system. As shown, the mobile device or ME 301 comprises a ME main processor 335 which is operatively coupled to:
a subscriber identification module (SIM) 350, comprising a SIM processor 351 and a SIM memory 352. SIM 350, also referred to as U (Universal) SIM, comprises identification data to identify the user of the mobile device 301 as a subscriber to a cellular communication network. SIM memory 352 may further comprise computer program instructions that cause the SIM processor 351 to implement an embodiment of the present method,
a mobile device memory 342 for storing for instance the user phone book, the mobile device operating system (OS), as well as computer program instructions that cause the ME main processor 335 to implement another embodiment of the present method,
a microphone 336 and a loudspeaker 337 enabling the user to input voice and hear audio output from the mobile device 301,
selecting means, i.e. a user input interface such as a keyboard or a touch screen 340, by which the user can input and/or select numbers to be called and other information and also can access and control various features of the mobile telephone 301;
a display 341 on which the number to be called and other information can be displayed; and
sending and receiving means, respectively a radio transmitter and receiver 338, comprising an antenna 339, for transmitting and receiving communications, including short messages to and from the communication network.

In the present system, as mentioned before, the short messages can be of at least two types, a display type and a data update type. Furthermore, the processor 335, operatively coupled to the receiving and sending means 338, is arranged, as explained before to generate:
a short message delivery receipt to a communication party, after normal receipt by the communication device of a first short message sent by the communication party. Such a short message (SM) delivery receipt, or tag, is generally in a byte format different than the received short messages,
mobile originated (MO) short messages, of the same byte format as the received short messages. The MO short messages are generally generated upon request from the SIM 350 to the processor 335,

In the present system, as explained with existing MEs, different proves of receipt (PoR) messages are envisaged to confirm normal receipt of data download short message by the SIM:
the short message delivery receipt or tag mentioned here above, when the (U)SIM (based on the sending entity's preferences, e.g. the SPI parameter), requests that PoR data be inserted therein. The short message delivery receipt comprising the PoR is sent back by the ME to confirm safe or normal receipt by the SIM of the data update. As mentioned before, this tag is of a different byte size than a regular SMS,
a new MO short message, generated by the ME and its SIM, when the SIM (based on the sending entity's preferences) requests that PoR data be inserted therein. This MO short message is of the same byte size as a regular SMS.

In the present system, as seen later on, the PoR message may be either the short message delivery receipt or a new MO SMS, based on the sending entity request and/or the different actions undertaken by the SIM and/or the ME.

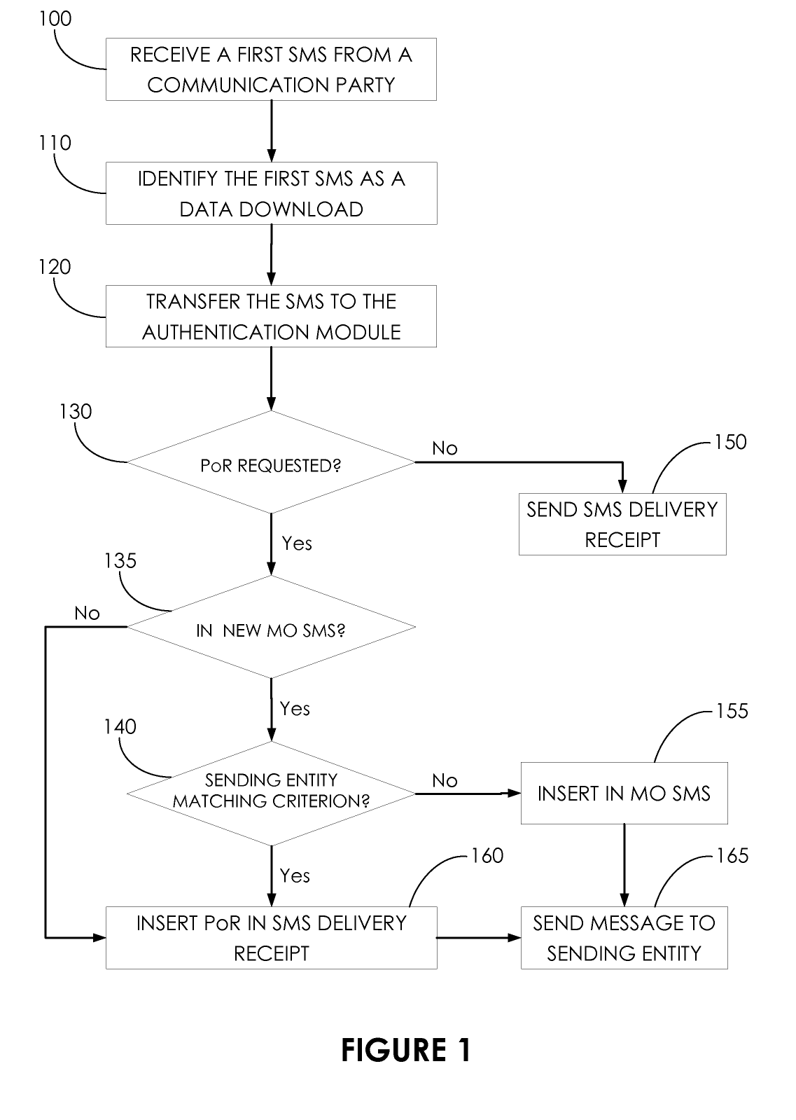

FIG. 1 illustrates an exemplary embodiment of the present method. In the present system, some sending entities cannot be trusted and therefore should not be authorized to modify the SIM memory 352. As explained later, a non trusted sending entity may be identified in the incoming message using a “non trusted” or predefined test.

In a preliminary step 100, the sending entity will send a first short message SMS to the ME (for instance through its MSISDN or Mobile Subscriber Integrated Services Digital Network Number). This first SMS is received using the receiving means 338 and transmitted to the ME processor 335. Processor 335 is adapted in a further step 110 to determine the received SMS type. This may be for instance data download or display, as mentioned earlier. If the SMS type is found to be “data download”, using for instance a first filtering rule on the parameters TP-PID/TP-DCS, in a further step 120, the ME processor 335 will transfer the received first SMS to the authentication module, i.e. (U)SIM 350. An illustration of this can be found in 3GPP TS 31.111 “Universal Subscriber Identity Module (USIM) Application Toolkit (USAT)” which discloses that the processor 335 shall not display the message and shall pass the message transparently to the SIM 350.

In a subsequent step 130, once the SIM 350 has received the first short message as identified of the data update type, it will verify/determine using the first SMS if a proof a receipt (PoR) of the data update is requested by the sending entity. As explained before, the SIM 350 may use in the payload of the received first SMS the SPI parameter. Provided the first two bits of the second byte of SPI are set to 0 1 or 1 0, a PoR is requested. When no PoR is requested (first two bits set to 0 0), the SMS handling procedure is executed as known from the 3GPP Standard. For instance, the SIM 350 may instruct the ME processor to reply with a simple short message delivery receipt (provided for instance it was requested by the sending entity) to confirm to the sending entity normal receipt by the ME of the first short message in a further step 150 (answer No to step 130)

When a PoR is requested (answer Yes to step 130), the SIM 350 will then determine (i.e. check) in a further step 135 what PoR message is requested by the sending entity, i.e. if the sending entity requests that the PoR data issued by the SIM 350 be inserted in a new MO short message or the short message delivery receipt, both serving as PoR messages for the sending entity. As seen before, this may be checked through the SPI parameter if the sixth bit of the second byte is set to 1(PoR data submitted in a new MO SMS). Steps 130 and 135 may be performed simultaneously. Whether in one or two steps, the checking of the SPI parameter can be seen as applying a second filtering rule (on SPI). If not (answer No to step 135), the SIM may instruct the ME processor 335 to insert PoR data in the short message delivery receipt intended to the sending entity in a further step 160 to confirm safe receipt by the SIM and/or implementation of the data update comprised in the initial SMS.

Provided a new MO SMS is requested by the sending entity (answer Yes to step 135), in a further step 140, the communication party is matched against a first predefined criterion. In the present system, PoR data may be inserted in new MO short messages only for authorized communication parties. An authorized communication party may be identified/sorted out from non authorized communication parties using the predefined criterion as illustrated here after.

In the existing 3GPP standard, the SIM instructs the ME and its processor 335 to execute different functions. The SIM of the present system may be further arranged to:
check if the communication party matches the predefined criterion,
obtain from the processor (i.e. request from the processor) the insertion of PoR data in a new MO short message in a further step 155, when the communication party does not match the predefined criterion (answer No to step 140). This may for instance correspond to an authorized communication party,
obtain from the processor (i.e. request from the processor) the insertion of the PoR data in the short message delivery receipt, in a further step 160, when the communication party matches the predefined criterion (answer Yes to step 140).

In both instances (steps 155 or 160), the processor 335 is arranged to follow the SIM requests and to:
generate the PoR message by inserting PoR data in either a new MO short message or the short message delivery receipt, and,
send the PoR message to the communication party.

In an alternative embodiment of the present system, one may envisage that the processor 335 will proceed with step 140 by matching the sending entity against the predefined criterion. The SIM acts as a known SIM from the prior art, i.e. that it will accept the sending entity's preferences for a new MO short message and proceed with requesting to the processor 335 to insert the PoR data in the new MO short message, as requested by the communication party.

In this alternative embodiment, the SIM requests the processor for the PoR message using a new MO short message (corresponds to step 135).

Upon detecting that a PoR message using a new MO SMS is requested, the processor will carry step 140, i.e. it will determine that the communication party, i.e. the recipient of the new MO short message, matches the predefined criterion. If not (answer No to step 140), it will insert the PoR in a new MO short message in the step 155, as requested by the SIM. If so (answer Yes to step 140), it will insert the PoR data in the short message delivery receipt in step 160. In other words, the processor 335 will obtain (i.e. generate) a PoR message using the short message delivery receipt comprising PoR data therein for subsequent transmission to the communication party. The request for a new MO short message as a PoR message is discarded.

Whether the SIM 350 or the main processor of the ME 335 checks the predefined criterion, that checking may be carried out using the sending entity identifier TP-OA found in the received short message header and/or other parameters of said received short message.

In the exemplary embodiment of FIG. 1, the short message delivery receipt is assumed to have been requested by the sending entity. The SIM may nevertheless obtain from the processor to insert the PoR data in a short message delivery receipt in step 160, even when not requested by the sending entity. Alternatively, no PoR message will be inserted in a short message delivery receipt in step 160 if no short message delivery receipt was requested.

In a further embodiment, the request for a new MO short message comprising the PoR data may be rejected for all sending entities. In other words, the predefined criterion is matched for all sending entities. Thus, a request for a PoR message using a new MO short message is never granted, whatever the sending entity may be.

Alternatively, non trusted communication parties may be defined through the use of a list, either comprising:
the list of non trusted entities (provided they are known), the predefined criterion is then matched if the communication party sending the first SMS belongs to this list of non trusted communication parties, or
the list of trusted entities (assuming that an unknown sending entity is necessarily a non trusted one), the predefined criterion is then matched if the communication party is not found in a list of trusted communication parties.

Such lists can comprise the entities identifiers, the matching being a simple comparison of the sending entity identifier to the list of trusted/non trusted entities identifiers.

Provided the predefined criterion is not matched by the sending entity (answer No to step 140), i.e. the sending entity can be trusted, the processor 335 will insert the PoR (either by itself or as instructed by the SIM 350) in a new MO short message in a further step 155.

In a further step 165, either subsequent to steps 155 or 160, the processor will proceed using the sending means 338 to send the generated PoR message (either the short message delivery receipt from step 160 or the new MO SMS of step 155) to the sending entity.

The present mobile device may be updated using a data update SMS or a data update IP packet (BIP) or any other means of remote update to make it operable to carry out the present method of controlling the delivery receipt sent by a mobile device in a wireless communication network after receiving a short message from a communication party.

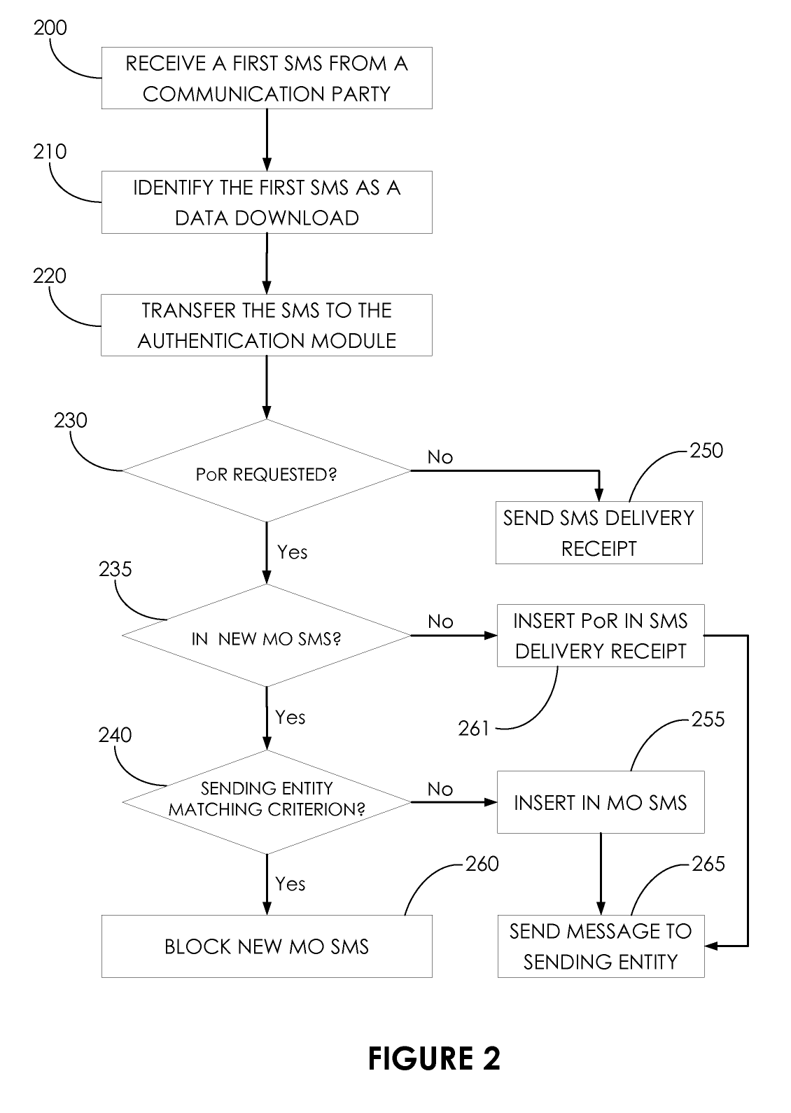

FIG. 2 illustrates another exemplary embodiment of the present method. In this embodiment, any request from the sending entity for a new MO short message comprising the PoR may be blocked when the sending entity is not trusted.

Steps 200 to 230 correspond respectively to steps 100 to 130 of FIG. 1, and step 250 to step 150, and are not further detailed.

When a PoR is requested (answer Yes to step 230), the SIM 350 will then determine (i.e. check) in a further step 235 what PoR message is requested by the sending entity, i.e. if the sending entity requests that the PoR data issued by the SIM 350 be inserted in a new MO short message or the short message delivery receipt, both serving as PoR messages intended for the sending entity. As seen before, this may be checked through the SPI parameter if the sixth bit of the second byte is set to 1 (PoR data submitted in a new MO SMS). If not (answer No to step 235), the SIM may instruct the ME processor 335 to insert PoR data in the short message delivery receipt intended to the sending entity in a further step 261. Then the short message delivery receipt, serving as a PoR message is sent by the processor 335 (step 265) to confirm the implementation of the SIM data update.

Provided a new MO SMS is requested by the sending entity (answer Yes to step 235), in a further step 240, the communication party is matched against a first predefined criterion, similar to the predefined criterion illustrated in relation to FIG. 1. In the present system, PoR data may be inserted in new MO short messages only for authorized communication parties. An authorized communication party may be identified/sorted out from non authorized communication parties using the predefined criterion as illustrated here after.

In the existing 3GPP standard, the SIM instructs the ME and its processor 335 to execute different functions. The SIM of the present system may be further arranged to:
check if the communication party matches the predefined criterion,
discard, i.e. block or reject, the insertion of PoR data in a new MO short message in a further step 260, when the communication party matches the predefined criterion (answer Yes to step 240). This may for instance correspond to an unauthorized communication party,
obtain from the processor (i.e. request from the processor) the insertion of PoR data in a new MO short message in a further step 255, when the communication party does not match the predefined criterion (answer No to step 240). This may for instance correspond to an authorized communication party. Subsequently, the processor 335 will execute the SIM instructions and generate the PoR message by inserting PoR data in a new MO short message (step 255) and send the resulting PoR message to the communication party (step 265).

In an alternative embodiment of the present system, one may envisage that the processor 335 will proceed with step 240 by matching the sending entity against the predefined criterion. The SIM acts as a known SIM, i.e. it will accept the sending entity's preference and instruct the processor 335 to insert PoR data in a new MO short message.

In this alternative embodiment, the SIM requests the processor for the PoR message using a new MO short message (corresponds to step 235).

Upon detecting that a PoR message using a new MO short message is requested (step 235 performed by the (U)SIM 350), the processor will carry step 240, i.e. it will determine whether the communication party matches the predefined criterion. If not (answer No to step 240), it will insert the PoR data in a new MO short message in the step 255, as requested by the SIM. If so (answer Yes to step 240), it will discard the sending entity request for a new MO short message as a PoR message. In other words, the processor 335 will block or reject the SIM instructions for the PoR message.

In the present method illustrated with the exemplary embodiments of FIGS. 1 and 2, whether implemented by the (U)SIM or the ME processor, one may see that a “PoR rule” is applied to the PoR message (requested as new MO short message comprising the PoR data) when the communication party matches the predefined criterion. The PoR rule defines how the PoR message requested by the sending entity is handled. As illustrated with the embodiments of FIGS. 1 and 2, that PoR rule may be respectively:
that the PoR data is inserted in the short message delivery receipt in place of the new MO short message,
that the request for the PoR data is discarded.

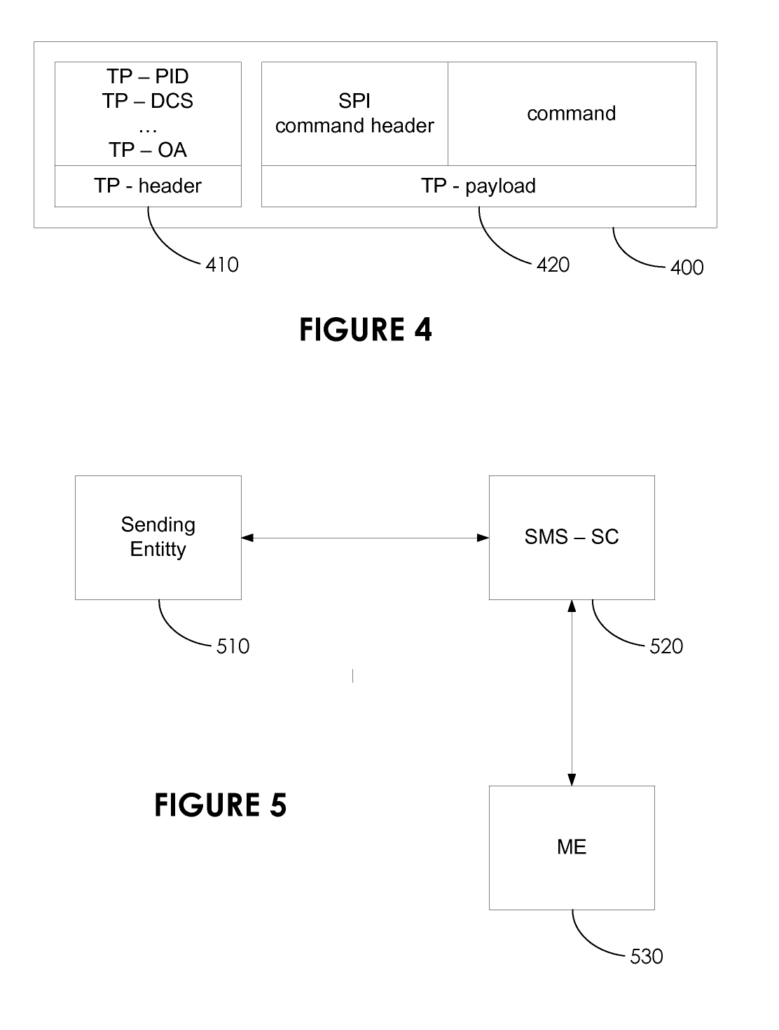

In the here above illustrations described in relation to FIGS. 1 and 2, the predefined criterion has been illustrated as a simple check if the sending entity identifier (known from the parameter TP-OA in the SMS header, see FIG. 4) can be found in a list comprising either trusted or non trusted entities.

In an alternative embodiment of the present system, the checking may use security keys to determine whether the sending entity can be trusted by the (U)SIM. In the existing 3GPP standard, security keys Kic and Kid are defined as keys whose values are only known and shared by each edge of the SMS transmission chain, namely the (U)SIM card and the remote card management platform.

By using one of these two security keys in the command header of the data download SMS, the (U)SIM will be able to check if the data download short message, and consequently the PoR request comprised therein, comes from a trusted sending entity (the trusted sending entity and the (U)SIM card shared the same secret keys).

In order to use this security mechanism based on shared secret keys, the SPI parameter of the command header of the data update SMS must be set by the sending entity to either:
01: Redundancy Check
10: Cryptographic Checksum

As with the previous illustration, a non trusted sending entity will match the predefined criterion, using the security keys. The predefined criterion is matched for the sending entity when one or more of the security keys found in the command header does not correspond to the security keys known to the U(SIM).

When the predefined criterion is verified by the (U)SIM, the (U)SIM will look directly into the command header of the received data update SMS if the security keys are known. When the predefined criterion is verified by the processor of the ME, the ME may collect one or more security keys from the command header, and request to the SIM to verify whether the collected security keys are known.

In the illustration here above, the controls on the sending entity are performed at the ME or (U)SIM level. It may be interesting to perform the controls of the PoR messages upstream the ME, i.e. in a network entity that can monitor the different SMS sent to the mobile equipments in the present system. The control of the PoR message is then network based, as opposed to ME based in the previous illustrations.

In an additional embodiment of the present system, a preventive action may be carried out in a node of the wireless communication network that can intercept all the SMS exchanged between sending entities 510 and MEs 530 in this network (illustrated in FIG. 5). This may be for instance the Short Message Service Center 520 of FIG. 5. This may also be carried out in the Mobile Switching Center MSC, in a Media Gateway Controller MGC of the network or any network element with SMS processing capabilities.

In this additional embodiment, the SMS sent by the sending entity 510 is blocked in the mobile network before reaching the ME 530, provided the sending entity is identified as a non trusted entity. Thus, the sending entity's identifier (or number) is verified before executing the SMS delivery procedure to the ME.

As detailed here after, the node implementing the network based control of the PoR messages may apply a three stage filtering approach based either on the sending entity identifier (e.g. using the TP-OA comprising the MSISDN or a short number of the sending entity) and the transport protocol parameters (i.e. at different layers TP-PID, TP-DCS and SPI in the short message).

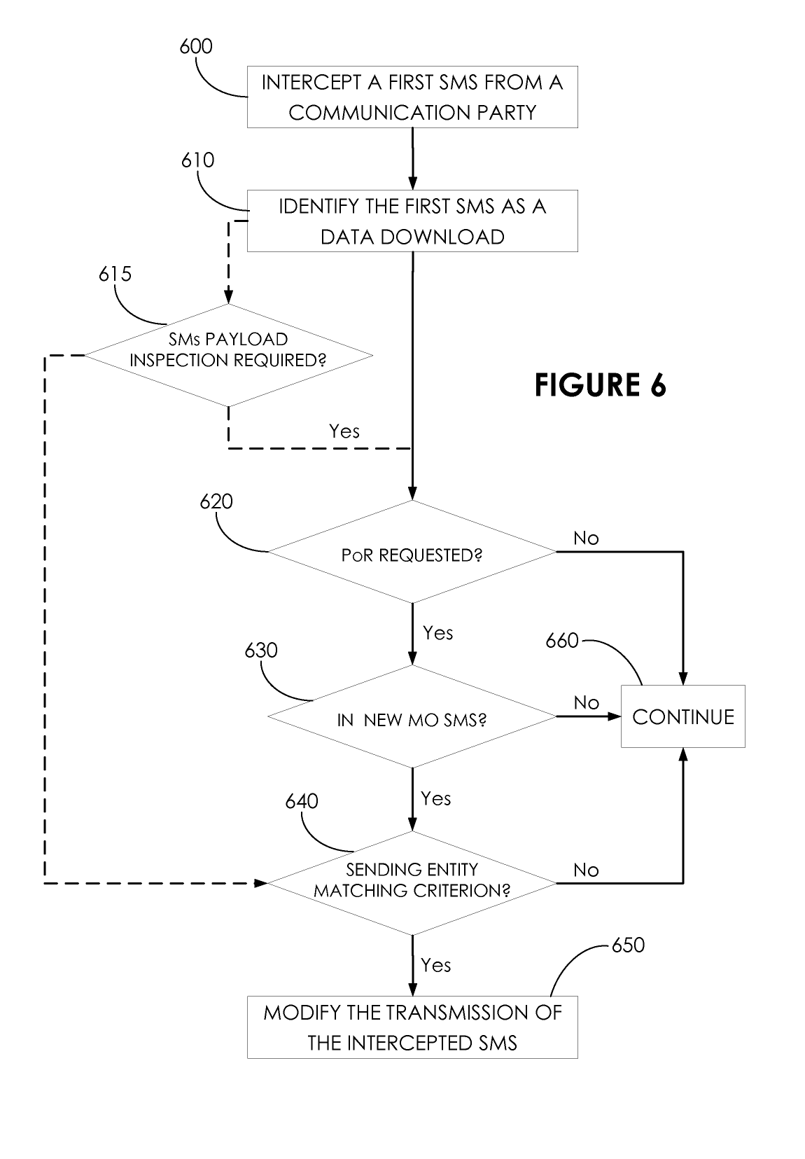

FIG. 6 is an exemplary illustration of another embodiment of the present method. The network node performing the PoR check will be illustrated here after as being the SMSC 520 of FIG. 5.

In a preliminary act 600, a first SMS is intercepted after being sent by the sending entity 510 to a ME 530. Provided it is identified as a data download SMS in a subsequent step 610 (using for instance a first filtering rule on the parameters TP-PID/TP-DCS), the SMSC 520 will check in a further step 620 if a PoR message in a new MO short message is requested from the ME (i.e. its (U)SIM) by the sending entity.

In order to implement the step 620, the SMSC will verify if an indication in the intercepted first message shows such a request from the sending entity, the SMSC may check the SPI parameter, similarly to the other illustrations of FIGS. 1 and 2.

As seen from FIG. 4, the TP-PID, TP-DCS and TP-OA parameters are not in the same message layer as the SPI parameter. Step 620 requires a payload inspection of the intercepted SMS in order to access the SPI parameter. Such a payload inspection requires the verification of a different layer than the first filter on the TP-PID and TP-DCS parameters. This can be resource consuming to inspect all intercepted SMSs, or even the one of the data download type. The payload inspection ought to be optimized and applied only to the SMS really susceptible of triggering a PoR message from the (U)SIM card.

The introduction of this network based control of the SMSs must reduce as much as possible its impact on the QoS (quality of service) performances of the SMS services, for instance by avoiding inspection of SMSs not concerned (for instance “Class 0” which are the most common SMS).

In an optional step 615 subsequent to step 610, SMSC will check if the payload inspection is required. Provided it is (answer Yes to step 615), the SMSC will in a further act 620 verify if a PoR message is requested by the sending entity. Provided the payload inspection is not required (answer No to step 615), the payload inspection of step 620 is skipped and the SMSC will only performed a check on the sending entity identifier TP-OA in step 640 detailed later on.

The payload inspection may be required systematically by the operator (preset) or vary depending on a number of characteristics linked to the transmission of the intercepted short message. More generally the payload inspection may be activated as long as one or more of the transmission characteristics match(es) a second predefined criterion. Indeed, such transmission characteristics as the time of the day may be monitored by the operator so that at certain times of the day, the payload inspection will be waived to avoid an undue burden on the SMSC 520. These times of the day may be defined e.g. through a statistical approach and correspond to periods of times when the message overhead (number of transmitted SMSs) is high. The number of previous payload inspections over a given period of time may also come into play to either activate or deactivate the payload inspection. When a large number of payload inspections have already been carried out, it may be of interest to the operator to deactivate the payload inspection so as to no longer overload the SMSC 520.

If no PoR message is required (answer No to step 620), the SMSC will continue with the normal sending procedure in step 660 and forward the intercepted first SMS to the recipient ME 530. When a PoR message is required (answer Yes to step 620), the SMSC will verify if the PoR message is requested using a new MO short message. As explained before, the acts 620 and 630 may be carried out using a second filtering rule on the SPI parameter. If not requested (answer No to step 630), the SMSC will carry on with step 660, and forward the intercepted short message to the ME 530.

Provided there is an indication that the PoR message is requested in a new MO short message (answer Yes to both steps 620 and 630), the SMSC 520 will apply a third filtering rule (the first predefined criterion mentioned before in relation to FIGS. 1 and 2) to the sending entity identifier, using for instance the TP-OA parameter in a further step 640.

As seen with the previous exemplary embodiments of FIGS. 1 and 2, if the sending entity identifier (e.g. TP-OA) matches the predefined criterion (answer Yes to step 640, e.g. is not a trusted entity), the SMSC will modify the transmission of the intercepted first short message in a further step 650. Reversely (answer No to step 640), the SMSC will process with step 660 and forward the intercepted first message to the ME 530 it was initially intended for.

The modification of the transmission in step 650 may e.g. be:
the blocking of the transmission, as it is not desirable that such short messages reached the recipient ME,
the modification of the intercepted short message itself. Indeed it may be of interest to the operator to alter this message so that the PoR message uses the short message delivery receipt in place of a new MO short message. To that extend, the indication/parameter SPI to the value may be modified by the SMSC by setting in SPI the sixth bit (b6) of the second byte to 0.

The choice between these two options may be preset by the operator or may be dependent on a number of parameters such as time of transmission of the intercepted SMS, sending entity, number of previous modifications (in order to avoid an overload of PoR message using the MO short message in the system).

Step 640 is also carried out when the payload inspection of optional step 615 is not required. As the SPI parameter is not checked, all the data download short messages issued by non trusted entity are modified (step 615 followed by step 640). When the payload inspection is required, (step 615 followed by steps 620 to 640), only the transmissions of the data download messages with:
an indication that the PoR is requested in a new MO short message (the first two bits of the second byte of SPI are set to 0 1 or 1 0) and
issued by a non trusted sending entity are modified. A significantly reduced number of payload verification is then performed with a limited impact on the QoS of the SMS service. One may note at this point that the ME 530 may also carry out the method illustrated in FIG. 6 as the ME can be seen as just another node of the communication network.

1. A mobile device (301) for use in a wireless communication network, said mobile device comprising a processor (335) arranged to:
send a short message delivery receipt to a communication party, after normal receipt by the communication device of a first short message sent by said communication party, said first short message delivery receipt being in a byte format different than the received first short message,
send mobile originated (MO) short messages, of the same byte format as the received first short message,
transfer the received first short message to an identification module (350) of the mobile device when said first short message is identified as a data update message comprising a data update for said identification module, either one of the processor and the authentication module being further arranged, upon determination by the authentication module that the communication party requested that proof of receipt (PoR) data for the data update be inserted in a new MO short message serving as a PoR message to said communication party, to discard said PoR data request when said communication party matches a predefined criterion.

2. The device of the previous claim, wherein the predefined criterion is checked by the authentication module, said authentication module being further arranged to discard the PoR data request when the communication party matches the predefined criterion.

3. The device of the previous claim 1, wherein the predefined criterion is checked by the processor, said processor being further arranged to discard the request from the authentication module for a new MO short message comprising the PoR data, when the communication party matches the predefined criterion.

4. The device of one of the previous claims, wherein the predefined criterion is matched for all communication parties.

5. The device of one of previous claims 1 to 3, wherein the predefined criterion is matched if the communication party belongs to a list of non trusted communication parties.

6. The device of one of the previous claims 1 to 3, wherein the predefined criterion is matched if the communication party is not found in a list of trusted communication parties.

7. The device of one of the previous claims 1 to 3, wherein the first message comprises at least one security key for the communication party, the predefined criterion being matched by said communication party when the at least one security key is not known to the authentication module,

8. The device of one of the previous claims, wherein the processor is further arranged to send a new MO short message comprising the requested PoR data when the communication party does not match the predefined criterion,

9. A method for controlling the proof of receipt (PoR) messages sent by a mobile device (301) in a wireless communication network after receiving a short message from a communication party, said mobile device comprising a processor (335) arranged to:
send a short message delivery receipt to the communication party, after normal receipt by the communication device of a first short message sent by said communication party, said first short message delivery receipt being in a byte format different than the received first short message,
send mobile originated (MO) short messages, of the same byte format as the received short messages,
transfer the received first short message to an identification module (350) of the mobile device when said first short message is identified as a data update message comprising a data update for said identification module, the method comprising, for one of the authentication module and the processor, the steps of:
determine whether the communication party requests that PoR data for the data update be inserted in a new MO short message serving as a PoR message to said communication party,
if requested, discard the communication party request when determining that said communication party matches a predefined criterion.

10. A wireless communication system comprising:
a communication party arranged to send data update type of short message to mobile devices of the communication system,
a mobile device (301) for use in a wireless communication network, said mobile device comprising a processor (335) arranged to:
send a short message delivery receipt to a communication party, after normal receipt by the communication device of a first short message sent by said communication party, said first short message delivery receipt being in a byte format different than the received first short message,
send mobile originated (MO) short messages, of the same byte format as the received first short message,
transfer the received first short message to an identification module (350) of the mobile device when said first short message is identified as a data update message comprising a data update for said identification module,
either one of the processor and the authentication module being further arranged, upon determination by the authentication module that the communication party requested that proof of receipt (PoR) data for the data update be inserted in a new MO short message serving as a PoR message to said communication party, to discard said PoR data request when said communication party matches a predefined criterion.

11. A computer readable carrier including computer program instructions that cause a computer to implement a method for controlling the delivery receipt sent by a mobile device in a wireless communication network after receiving a short message from a communication party according to claim 9.
